(19) United States
(12) Patent Application Publication
(10) Pub. No.: US 2010/0015406 A1
(43) Pub. Date: Jan. 21, 2010

(54) Laminated felt articles

(76) Inventors: Ashok Bhatnagar, Richmond, VA (US); Lori L. Wagner, Richmond, VA (US); Harold Lindley Murray, JR., North East, MD (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 11/130,361

(22) Filed: May 16, 2005

(51) Int. Cl. B32B 3/06; D04H 1/08; B32B 5/00; B32B 5/26

(52) U.S. Cl. 428/193; 442/324; 428/219; 442/286

(57) ABSTRACT

Laminated felt sheets, and assemblies thereof, having utility for impact absorption, ballistic resistance, penetration resistance per se, as well as in spall shields, structural composites and other applications.

### BACKGROUND OF THE INVENTION

1. Field of the Invention

The invention relates to laminated felt sheets, and assemblies thereof, having utility for impact absorption, ballistic resistance, penetration resistance per se, as well as in spall shields, structural composites and other applications.

2. Description of the Related Art

The construction of body armor for personal protection is an ancient but not archaic art. Metal armor, already well known to the Egyptians by 1500 B.C., persisted in use until about the end of the 17^{th} century. In recent times, body armor has again become practical through the discovery of new strong fibers such as aramids, high molecular weight polyethylene, and polybenzazoles.

Various fiber-reinforced constructions are known for use in impact-resistant, ballistic-resistant and penetration-resistant articles such as helmets, panels, and vests. These articles display varying degrees of resistance to penetration by impact from stabbing implements such as knives and spikes or projectiles such as bullets, shells, shrapnel, glass fragments and the like.

Ballistic-resistant and/or penetration-resistant articles which include high strength fibers made from materials such as high molecular weight polyethylene, aramids and polybenzazoles are known. See, e.g., U.S. Pat. Nos. 6,534,426, 6,475,936, and a 1984 publication of E.I. duPont De Nemours International S.A. entitled “Lightweight Composite Hard Armor Non Apparel Systems with T-963 3300 dtex DuPont Kevlar 29 Fibre.” The fibers may be woven or non-woven. Non-woven fibers may be knitted, uniaxially aligned and cross-plied, or felted. Such articles are said to be either flexible or rigid depending upon the nature of their construction and the materials employed.

U.S. Pat. No. 4,181,768 describes a rigid armor formed by press laminating alternate layers of 6,6 nylon film and poly-(p-phenylene terephthalamide) fabric. The fabric can be a non-woven such as a needle-punched felt. U.S. Pat. No. 5,343,796 describes armor systems comprising a first pliable fibrous layer and a second pliable cut resistant fibrous layer. The second layer comprises an uncoated needle-punched felt. US Patent Application Publication 2002/0106956 describes fabric articles comprising at least two fiber types: one having a tenacity of at least 10 g/d and another having a tenacity of less than 10 g/d. The fabrics have a layer resistant to puncture by thorns, snake bite, sharp branches and the like, and may have a microporous membrane layer behind the puncture resistant layer. The puncture resistant layer can be a needle-punched felt.

US Patent Application Publication 2003/0022583 describes ballistic resistant fabric comprising at least two types of fibrous materials blended and consolidated together to create a single layer of composite material. The fibrous materials are consolidated by needle punching and compression. H. L. Thomas, discusses “Needle-punched Non-woven Fabric for Fragmentation Protection”, in materials presented at the 14^{th} International Conference on Composite Materials, Jul. 14-18, 2003, San Diego, Calif.

Complete analysis of penetration of fiber-reinforced composites is still beyond present capabilities, although several mechanisms have been identified. A small pointed projectile can penetrate armor by laterally displacing fibers without breaking them. In this case, the penetration resistance depends on how readily fibers may be pushed aside, and therefore, on the nature of the fiber network. Important factors are the tightness of weave or periodicity of cross-overs in cross-plied unidirectional composites, yarn and fiber deniers, fiber-to-fiber friction, matrix characteristics, interlaminar bond strengths and others. Sharp fragments can penetrate by shearing fibers.

The earlier constructions had several disadvantages. Cross-plied unidirectional fiber composites generally have better ballistic resistance and weigh less than woven fabrics made from the same fiber type, however, they are typically more costly to produce. Each of the constructions cited above represents progress toward the goals to which they were directed. However, none described the specific constructions of the laminates and assemblies of this invention, and none satisfied all of the needs met by this invention.

### SUMMARY OF THE INVENTION

The invention comprises laminated felt sheets, and assemblies thereof, having utility for impact absorption, ballistic resistance and penetration resistance per se, as well as in spall shields, structural composites and other applications. Surprisingly, it is found that constructions of the invention provide unexpected reduction in back face deformation when impacted by ballistic projectiles, and improved resistance to penetration by stabbing implements.

In one embodiment, among others, the invention is a freestanding laminate comprising: a compressed felt sheet comprising two lateral surfaces and consisting essentially of one or more high strength fibers having a tenacity equal to or greater than about 17 grams per denier (g/d) as measured by ASTM D2256-02; plastic film bonded to one or both lateral surfaces of the felt sheet; and optionally, bonding material between the lateral surface(s) and the plastic film.

Another embodiment is an article comprising two or more of the inventive laminates stacked together in face-to-face relationship, wherein the laminates are connected only in an edge portion.

A further embodiment is an article comprising two or more of the inventive laminates having a bonding material between the lateral surfaces of the felt and the plastic film, wherein the laminates are bonded together in face-to-face relationship.

Yet another embodiment is an article comprising one or more of the inventive laminates described above in combination with one or more fibrous layers selected from the group consisting of woven sheets of high strength fibers, sheets of uniaxially-aligned and cross-plied high strength fibers in a matrix, sheets of uniaxially-aligned and cross-plied high strength fibers laminated in a plastic film, said high strength fibers having a tenacity of at least about 17 g/d;

wherein said fibrous layers and said laminates are stacked together in face-to-face relationship.

A still further embodiment is an article comprising one or more of the inventive laminates previously described in combination with a rigid plate selected from the group consisting of: sheets of woven high strength fibers in a matrix, bonded together; sheets of uniaxially-aligned and cross-plied high strength fibers in a matrix, bonded together; sheets of uniaxially-aligned and cross-plied high strength fibers laminated in a plastic film and bonded together; wherein the rigid plate and the inventive laminates are stacked together in face-to-face relationship.

A yet further embodiment is an article comprising: one or more of the previously described inventive laminates in combination with a rigid plate selected from the group consisting of a ceramic, a glass, a metal-filled composite, a ceramic-filled composite, a glass-filled composite and a cermet; wherein the rigid plate and the inventive laminates are stacked together in face-to-face relationship.

### BRIEF DESCRIPTION OF THE DRAWINGS

FIGS. 1-4 are schematic drawings of laminates of the invention.

FIG. 5 is a schematic drawing of an article of the invention.

### DETAILED DESCRIPTION OF THE INVENTION

High strength fibers used in ballistic- and/or penetration-resistant constructions are produced by complex processes, are intrinsically expensive and are also used in other applications such as ropes, commercial fishing nets, tire cord and a variety of reinforced plastic products, both military and civilian. In times when military demands are high, production capacity may not meet all needs. Because production capacity cannot be quickly increased, a need exists to more efficiently utilize the limited supply of high strength fibers. A thus far minimally exploited resource is the short fiber packages that all fiber production processes unintentionally produce because of breakage or other problems. Short fiber packages are undesirable for weaving or pre-pregging operations. However, fiber in these packages can be beneficially utilized in felted constructions.

The invention comprises novel laminated felt sheets, and assemblies thereof. In one embodiment, among others, the invention is a free-standing laminate comprising: a compressed felt sheet comprising two lateral surfaces and consisting essentially of one or more high strength fibers having a tenacity equal to or greater than about 17 grams per denier (g/d) as measured by ASTM D2256-02; plastic film bonded to one or both lateral surfaces of the felt sheet; and optionally, a bonding agent between the lateral surfaces of the felt and the plastic film.

Surprisingly, it is found that laminates and assemblies of the invention provide unexpected reduction in back face deformation when impacted by ballistic projectiles, and improved resistance to penetration by stabbing implements. The laminates of the invention also absorb less water when immersed than a felt material does.

For the purposes of the present invention, a fiber is an elongate body the length dimension of which is much greater that the transverse dimensions of width and thickness. Accordingly, the term fiber includes filament, ribbon, strip, and the like having regular or irregular cross-section. A yarn is a continuous strand comprised of many fibers or filaments.

Preferably the high strength fibers constituting the felt of the inventive laminate have a tenacity of at least 25 g/d, more preferably at least 30 g/d and most preferably at least 35 g/d as measured by ASTM D2256-02.

Preferably the high strength fibers constituting the felt of the inventive laminate are selected from the group consisting of polyolefin, polyaramid, polybenzazole, polyvinyl alcohol, and poly{2,6-diimidazo[4,5-b4′,5′-e]pyridinylene-1,4(2,5-dihydroxy)phenylene} (PIPD). More preferably, the high strength fibers are selected from the group consisting of polyethylene, poly(p-phenylene terephthalamide), polybenzoxazole (PBO), and poly{2,6-diimidazo[4,5-b4′,5′-e]pyridinylene-1,4(2,5-dihydroxy)phenylene} (PIPD).

As used herein, the term polyethylene means a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-l-polymers, in particular low density polyethylene, polypropylene or polybutylene, copolymers containing mono-olefins as primary monomers, oxidized polyolefins, graft polyolefin copolymers and polyoxymethylenes, or low molecular weight additives such as antioxidants, lubricants, ultra-violet screening agents, colorants and the like.

High strength polyethylene fibers may be grown from solution as described in U.S. Pat. No. 4,137,394 or U.S. Pat. No. 4,356,138, or spun from a solution tc) form a gel structure, as described in German Off. No. 3,004,699 and GE. No. 2,051,667, and especially as described in U.S. Pat. No. 4,413,110 and sold under the SPECTRA® trademark by Honeywell International Inc. The disclosure of U.S. Pat. No. 4,413,110 is hereby incorporated by reference to the extent that it is not inconsistent herewith. The polyethylene fibers may also be produced by a rolling and drawing process as described in U.S. Pat. No. 5,702,657 and sold under the TENSYLON® trademark by ITS Industries Inc.

In the case of aramid fibers, suitable fibers formed from aromatic polyamides are described in U.S. Pat. Nos. 3,671,542 and 5,010,168 which are hereby incorporated by reference. Aramid fibers are produced commercially by E.I. Dupont Co. under the KEVLAR® and NOMEX® trademarks; by Teijin Twaron BV under the TWARON®, TECHNORA® and TEIJINCONEX® trademarks; by JSC Chim Volokno under the name ARMOS; and by Kamensk Volokno JSC under the names RUSAR and SVM. Poly(p-phenylene terephthalamide) and p-phenylene terephthalamide aramid copolymer fibers having moderately high moduli and tenacity values are particularly useful in the present invention. An example of a p-phenylene terephthalamide copolymer aramid useful in the invention is co-poly-(paraphenylene 3,4′-oxydiphenylene terephthalamide). Also useful in the practice of this invention are poly(m-phenylene isophthalamide) fibers. Suitable polybenzazole fibers for the practice of this invention are disclosed for example in U.S. Pat. Nos. 5,286,833, 5,296,185, 5,356,584, 5,534,205 and 6,040,050 hereby incorporated by reference. Preferably, the polybenzazole fibers are ZYLON® poly(p-phenylene-2,6-benzobisoxazole) fibers from Toyobo Co.

Suitable PIPD fibers are disclosed in U.S. Pat. Nos. 5,674,969, 5,939,553, 5,945,537 and 6,040,478, hereby incorporated by reference. A preferred fiber is the M5® brand available from Magellan Systems International, LLC.

For the purposes of the invention, a felt is a non-woven network of randomly oriented fibers, preferably at least one of which comprises discontinuous fibers, preferably staple fiber, preferably having a length ranging from about 0.25 inches (0.64 cm) to about 10 inches (25 cm). There are several methods to lay such a random network of fibers, for example by carding or fluid laying (air or liquid), and melt blowing and spin laying as are conventional in the art. Consolidation of the network for handling, i.e. bonding of the network of fibers, can occur by any of the following means: mechanically, e.g., needle punching, stitch-bonding, hydro-entanglement, air entanglement, spun bond, spun-lace; chemically, e.g., with an adhesive; and thermally, with a fiber to point bond or a blended fiber with a lower melting point. The preferred consolidation method is needle punching alone or followed by one of the other methods. The most preferred felt is a needle punched felt.

Needle punching is a process by which webs of loose fibers are converted into a coherent non-woven fabric by mechanical entanglement on machinery called needle looms. Needle looms are manufactured, for example, by the firms of Oskar Dilo Maschinenfabrik KG, Eberbach/N, Germany, Ferher AG, Linz, Austria and Asselin, Elbeuf, France. During needle punching, barbed needles punch fiber into the web and withdraw leaving the fibers entangled. By varying the strokes per minute, the advance rate of the web, and the weight of the web, a wide range of felt densities can be made.

The felt component of the inventive laminate is preferably produced from a web having an areal density of from about 1 to 50 oz/yd² (0.034 to 1.67 Kg/m²), more preferably from about 2 to 20 oz/yd² (0.068 to 0.68 Kg/m²) and most preferably from about 4 to 10 oz/yd² (0.136 to 0.34 Kg/m²). Preferably, the needle punch density is from about 100 to 2000 per square inch (15.5 to 310 punches/cm²) of web, and more preferably from about 200 to 1000 punches/in² (31 to 155 punches/cm²).

The felt is mated with one or two plastic films on one or both of its lateral surfaces under heat and pressure sufficient to bond the plastic film to the felt surfaces and to compress the felt. Optionally, a bonding agent is applied to either the felt or the plastic film surfaces before mating the felt and the plastic film. The bonding agent may be applied as a solution, a melt or as a solid film.

The plastic film is selected from the group consisting of polyolefin, polyamide, polycarbonate, ionomer, polyimide, polyvinyl chloride, polyester and polyurethane films. Preferably, the plastic film is polyethylene, polyamide, polycarbonate, ionomer or polyester. Preferably, the plastic film has a thickness from about 0.008 mm to about 1 mm, and more preferably from about 0.008 mm to about 0.5 mm.

When a bonding agent is present in an inventive laminate, it comprises from about 1 to about 10 percent by weight of the laminate. Preferably, the bonding agent is an elastomeric material having a tensile modulus less than about 41.3 MPa as measured by ASTM D638-03.

A wide variety of elastomeric materials and formulations having appropriately low modulus may be utilized as a bonding agent. For example, any of the following materials may be employed: polybutadiene polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride using dioctyl phthalate or other plasticizers well known in the art, butadiene acrylonitrile elastomers, poly (isobutylene-co-isoprene), polyacrylates, polyesters, polyethers, fluroelastomers, silicone elastomers, thermoplastic elastomers, copolymers of ethylene. Preferably, the bonding agent is a tri-block copolymer of a vinyl aromatic monomer and a conjugated diene elastomer such as are produced commercially by Kraton Polymers Inc.

Preferably, the laminating pressure is from about 100 to 5000 psi (0.690 MPa to 34.5 MPa), The laminating temperature when no bonding agent is present is selected with respect to the softening point of the plastic film and/or the melting points of the high strength fibers. When the felt includes high strength polyethylene fibers, the laminating temperature is preferably from 100° C. to 130° C. When the felt contains only fibers melting above the melting point of the plastic film, then the laminating temperature is preferably from 100° C. to the softening point of the plastic film.

The softening point of a bonding agent should be at a lower temperature than the softening point of the plastic film or the melting point of the high strength fibers. When a bonding agent is present, the laminating temperature is from about the softening point of the bonding agent to about the softening point of the plastic film or to about 20° C. below the melting point of the lowest melting high strength fiber, whichever is lower.

The laminating operation bonds the plastic film to the felt and compresses the felt, making it more compact and dense. Preferably, a laminate of the invention has a density of from about 0.05 g/cm³ to 1.5 g/cm³ and more preferably, from about 0.1 to1.5 g/cm³. Preferably, a laminate of the invention has an areal density of from about 0.1 Kg/m² to about 2 Kg/m².

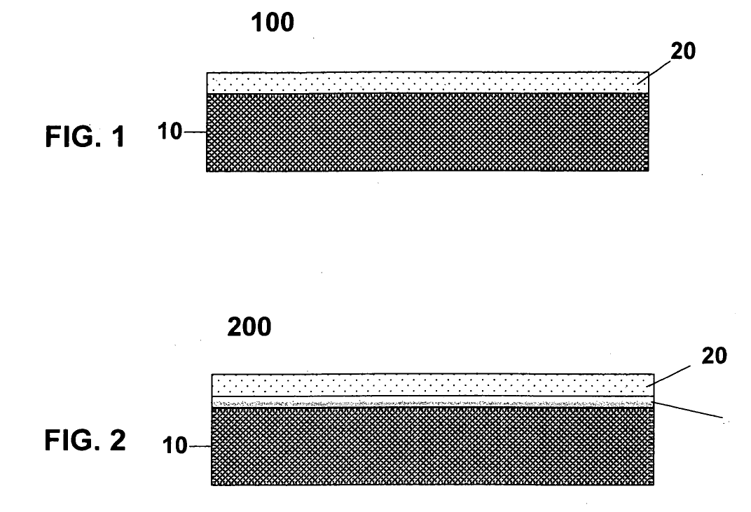

FIG. 1 schematically illustrates a laminate of the invention 100 consisting of a compressed felt 10 of high strength fibers and a plastic film 20 on one lateral surface of the felt 10. As shown in FIG. 2, a laminate of the invention 200 may have an optional bonding agent 30 between the felt 10 and the plastic film 20.

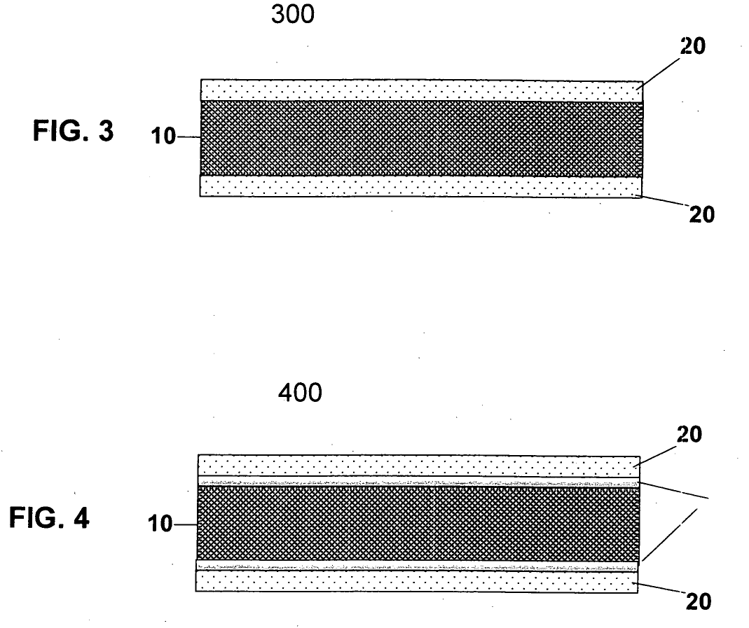

FIG. 3 schematically illustrates a laminate of the invention 300 consisting of a compressed felt 10 of high strength fibers and plastic films 20 on both lateral surfaces of the laminate 300. As shown in FIG. 4, a laminate of the invention 400 may have an optional bonding agent 30 between the lateral surfaces of felt 10 and plastic films 20.

Preferably, a laminate of the invention has a low apparent bending modulus as measured by ASTM D747-93. A low apparent bending modulus is equivalent to high flexibility. High flexibility insures that the laminate will readily conform to a human body. Preferably, a laminate of the invention has an apparent bending modulus of less than about 10 psi (137 KPa), more preferably less than about 5 psi (69 KPa), and most preferably less than about 2 psi (13.7 KPa), as measured by ASTM 747-93.

In another embodiment, the invention is an article comprising two or more laminates of the invention stacked together in face-to-face relationship, wherein the laminates are connected only in an edge portion, preferably by stitching. By “only in an edge portion” is meant the area within about 1.5 inches (3.8 cm) of the edge. Preferably, the laminates are not connected to one another. The assemblies of the invention may be contained within a pouch or envelope.

Preferably, the article is ballistically resistant, having against the 17 grain (1.1 gram) fragment simulating projectiles described by MIL-P-46593A, a V50 velocity of at least about 1800 ft/sec (549 m/sec), a specific energy absorption (SEA) of at least about 50. J-m2/Kg and a back face deformation at the V50 velocity of less than about 55 mm as measured by MIL-STD 662E.

The V50 velocity is that velocity at which a projectile has a 50% probability of penetrating the article. The specific energy absorption (SEA) is the kinetic energy of the projectile at the V50 velocity divided by the areal density of the article, the SEA having units of Joules-m²/Kg.

Preferably, the article is resistant to penetration by pointed objects, having against the “engineered spike” threat at a strike energy of 36 Joules, a penetration depth in millimeters, as measured by NIJ Standard 01150.00, September 2000, satisfying the following inequality:
Penetration Depth, mm<45/Article Areal Density, lb/ft²
(Penetration Depth, mm<220/Article Areal Density, Kg/m²).

A further embodiment of the invention is an article comprising two or more of the inventive laminates having a bonding material between the felt surfaces and the plastic film, described above, wherein the laminates are bonded together in face-to-face relationship.

Yet another embodiment is an article comprising one or more of the inventive laminates described above in combination with one or more fibrous layers selected from the group consisting of woven sheets of high strength fibers, sheets of uniaxially-aligned and cross-plied high strength fibers in a matrix, sheets of uniaxially-aligned and cross-plied high strength fibers laminated in a plastic film, said high strength fibers having a tenacity of at least about 17 g/d; wherein the fibrous layers and the inventive laminates are stacked together in face-to-face relationship.

A still further embodiment is an article comprising one or more of the inventive laminates previously described in combination with a rigid plate selected from the group consisting of: sheets of woven high strength fibers in a matrix, bonded together; sheets of uniaxially-aligned and cross-plied high strength fibers in a matrix, bonded together; and sheets of uniaxially-aligned and cross-plied high strength fibers laminated in a plastic film and bonded together; wherein the rigid plate and the inventive laminates are stacked together in face-to-face relationship.

A yet further embodiment is an article comprising: one or more of the previously described inventive laminates in combination with a rigid plate formed from a ceramic, a glass, a metal-filled composite, a ceramic-filled composite, a glass-filled composite and a cermet; wherein the rigid plate and the inventive laminates are stacked together in face-to-face relationship.

The following examples are presented to provide a more complete understanding of the invention. The specific techniques, conditions, materials, proportions and reported data set forth to illustrate the principles of the invention are exemplary and should not be construed as limiting the scope of the invention.

### EXAMPLES

### Comparative Example 1

A 1200 denier, 120 filament, high strength polyethylene yarn having a tenacity of 30 g/d as measured by ASTM D2256-02, commercially available from Honeywell International inc. as SPECTRA® 900 yarn, was chopped into lengths of 1.5 inches (3.81 cm). A non-woven web of randomly oriented, loosely connected high strength fibers was formed from these fibers by Tex Tech Industries, Portland, Me. The web was needle punched at a punch density of 600 punches/in² (93 punches/cm²) to produce a felt sheet having an areal density of 8 oz/yd² (0.27 Kg/m²) and thickness of 0.155 inch (0.394 cm). The apparent bending modulus of the felt sheet, as measured by ASTM D747-93, was 1.50 psi (10.3 KPa).

Thirteen unconnected sheets of this felt having dimensions of 16 in×16 in (41 cm×41 cm) were stacked in face-to-face relationship. The article consisting of the 2.02 in (5.12 cm) thick stack of felt sheets was clamped around its edges in an edge portion and subjected to ballistic testing by MIL-STD-662E, using 17 grain (1.1 gram), fragment simulating projectiles (FSP) described by MIL-P-46593A. The results of the ballistic testing are shown in Table I below.

### Comparative Example 2

A high strength polyethylene fiber felt sheet identical to that described in Comparative Example 1 was placed in a press and compressed at 200 psi (1.38 MPa) at a temperature of 116° C. for one hour. At the end of this time, the compressed felt was removed from the press and cooled to room temperature. The apparent bending modulus of the 0.022 inch (0.056 cm) thick compressed felt sheet, as measured by ASTM D747-93, was 0.53 psi (3.6 KPa).

Thirteen high strength polyethylene fiber felt sheets identical to those described in Comparative Example 1 were stacked together face-to-face. The stacked sheets were placed in a press and compressed at 200 psi (1.38 MPa) at a temperature of 116° C. for one hour. At the end of this time, the compressed stack was removed from the press and cooled to room temperature. The article consisting of the 16 in×16 in×0.325 in (41 cm×41 cm×0.826 cm) stack of compressed felt sheets was clamped around its edges in the edge portion and subjected to ballistic testing in a manner identical to that described in Comparative Example 1. The results of the ballistic testing are shown in Table I below.

### Example 1

A high strength polyethylene fiber felt sheet identical to that described in Comparative Example 1 was placed on a 0.00035 in (0.0089 mm) thick linear low density polyethylene film. The ensemble of the felt sheet and plastic film was placed in a press and compressed at 200 psi (1.38 MPa) at a temperature of 116° C. for one hour. At the end of this time, a laminate of the invention having a plastic film on one lateral surface of the felt was removed from the press and cooled to room temperature. The apparent bending modulus of the 0.022 inch (0.056 cm) thick laminate of the invention, as measured by ASTM D747-93, was 0.61 psi (4.2 KPa).

### Example 2

Thirteen laminates were prepared as in Example 1 and stacked together face-to-face. The article of the invention consisting of the stack of unconnected laminates, having dimensions of 16 in×16 in×0.52 in (41 cm×41 cm×1.32 cm), was clamped around its edges in the edge portion and subjected to ballistic testing in a manner identical to that described in Comparative Example 1. The projectile entered the film side of the articlE. Some properties of the article and results of the ballistic testing are shown in Table I below.

### Example 3

A high strength polyethylene fiber felt sheet identical to that described in Comparative Example 1 was placed between two 0.00035 in (0.0089 mm) thick linear low density polyethylene films. The ensemble of the felt sheet sandwiched between plastic films was placed in a press and compressed at 200 psi (1.38 MPa) at a temperature of 116° C. for one hour. At the end of this time, a laminate of the invention having plastic films on both surfaces was removed from the press and cooled to room temperature. The apparent bending modulus of the 0.025 inch (0.0635 cm) thick laminate of the invention, as measured by ASTM D747-93, was 1.65 psi (11.4 KPa).

### Example 4

Thirteen laminates were prepared as in Example 3 and stacked together face-to-face. The article of the invention, consisting of the stack of unconnected laminates and having dimensions of 16 in×16 in×0.455 in (41 cm×31 cm×1.16 cm), was clamped around its edges in the edge portion and subjected to ballistic testing in a manner identical to that described in Comparative Example 1. Some properties of the article and results of the ballistic testing are shown in Table I below.

### Example 5

A high strength polyethylene fiber felt sheet identical to that described in Comparative Example 1 was coated on both surfaces with a cyclohexane solution of a styrene-isoprene-styrene block copolymer (KRATON® D 1107) elastomeric bonding agent, followed by drying. The elastic modulus of the bonding agent was 200 psi (1.38 MPa) as measured by ASTM D638-03. The coated felt sheet was placed between two 0.00035 in (0.0089 mm) thick linear low density polyethylene films. The ensemble of the coated felt sheet sandwiched between plastic films was placed in a press and compressed at 200 psi (1.38 MPa) at a temperature of 116° C. for one hour. At the end of this time, a laminate of the invention having plastic films on both surfaces and a bonding agent between the felt and the plastic films was removed from the press and cooled to room temperature.

### Example 6

Thirteen laminates were prepared as in Example 5 and stacked together face-to-face. The article of the invention consisting of the stack of unconnected laminates, having dimensions of 16 in×16 in×0.975 in (41 cm×41 cm×2.48 cm), was clamped around its edges in the edge portion and subjected to ballistic testing in a manner identical to that described in Comparative Example 1. Some properties of the article and the results of the ballistic testing are shown in Table I.

It is seen that the V50 and SEA's of the felts of the Comparative Examples and the articles of the invention were not significantly different from one another. However, surprisingly, the articles of the invention having plastic films on the felt surface(s) showed much reduced back face deformation as compared to the either the uncompressed or compressed felts of the Comparative Examples.

Body armor must be capable of stopping a projectile, and additionally must protect the wearer against “blunt trauma”. If the projectile causes excessive back face deformation of the armor, serious injury or even death may result. It is seen that the articles of the invention, formed from the laminates of the invention, are both capable of effectively stopping a projectile and reducing the potential for blunt trauma injury.

Without being held to a particular theory of why the invention works, it is believed that a plastic film surface beneficially changes the mechanism of interaction of a projectile with the fibers in a felt.

### Comparative Example 3

A 210 denier, 60 filament, high strength polyethylene yarn having a tenacity of 38 g/d as measured by ASTM D2256-02, commercially available from Honeywell International Inc. as SPECTRA® 1000 yarn, was chopped into lengths of 3.0 inches (7.62 cm). A 1000 denier, 1.5 denier/fil high strength aramid yarn produced by Teijin Twaron and having a tenacity of 25 g/d as measured by ASTM D2256-02 was chopped into lengths of 3.0 inches (7.62 cm). The polyethylene and aramid chopped fibers were blended in 50/50 wt %/wt % proportions and a non-woven web of randomly oriented, loosely connected high strength fibers was formed from these fibers by Tex Tech Industries, Portland, Me. The web was needle punched at a punch density of 600 punches/in² (93 punches/cm²) to produce a felt sheet having an areal density of 7 oz/yd² (0.24 Kg/m²) and thickness of 0.12 inch (0.305 cm).

Fifteen unconnected sheets of this felt having dimensions of 16 in×16 in (41 cm×41 cm) were stacked in face-to-face relationship. The article consisting of the 2.02 in. (5.14 cm) thick stack of felt sheets was clamped around its edges

TABLE 1
Properties and Ballistic Performance of Inventive Articles

| | Percent by Wt. of | | | | | | | |
|---|---|---|---|---|---|---|---|---|
| | Article | | Article Properties | | | | | |
| | | Bonding | Thickness, | Areal Density, | Density, | V50 Velocity, | SEA, | Back Face |
| Ex. | Film | Agent | cm | Kg/m² | g/cm³ | m/sec | J − m²/Kg | Deformation, mm |
| Comp. 1 | — | — | 5.12 | 3.49 | 0.068 | 600 | 57 | 98 |
| Comp. 2 | — | — | 0.826 | 3.49 | 0.432 | 591 | 54 | 89 |
| 2 | 1 | — | 1.32 | 3.53 | 2.67 | 567 | 50 | 53 |
| 4 | 2 | — | 1.16 | 3.57 | 0.309 | 587 | 53 | 43 |
| 6 | 2 | 2 | 2.48 | 3.62 | 0.146 | 577 | 51 | 38 |

Fiber: Polyethylene (SPECTRA ® 900 brand)
Fiber Strength: 30 g/d
Chopped Fiber Length: 1.5 in (3.8 cm)
Areal Density of Single Felt Sheet: 0.0556 lb/ft² (0.27 Kg/m²)
No. of Laminates or Felt Sheets: 13
Film: LLDPE, 0.00035 in. (0.0089 mm)
Projectile: 17 gr. FSP

in the edge portion and subjected to ballistic testing by MIL-STD-662E, using 17 grain (1.1 gram), fragment simulating projectiles (FSP) described by MIL-P-46593A. The results of the ballistic testing are shown in Table II below.

### Example 7

A high strength polyethylene/aramid felt sheet identical to that described in Comparative Example 3 was placed between two 0.00035 in (0.0089 mm) thick linear low density polyethylene films. The ensemble of the felt sheet sandwiched between plastic films was placed in a press and compressed at 200 psi (1.38 MPa) at a temperature of 116° C. for one hour. At the end of this time, a laminate of the invention having plastic films on both surfaces was removed from the press and cooled to room temperature.

### Example 8

Fifteen laminates were prepared as in Example 7 and stacked together face-to-face. The article of the invention consisting of the stack of unconnected laminates, having dimensions of 16 in×16 in×0.90 in (41 cm×41 cm×2.29 cm), was clamped around its edges in the edge portion and subjected to ballistic testing in a manner identical to that described in Comparative Example 1. Some properties of the article and results of the ballistic testing are shown in Table II below.

### Example 9

A high strength polyethylene/aramid fiber felt sheet identical to thatdescribed in Comparative Example 3 was coated on both surfaces with a cyclohexane solution of a styrene-isoprene-styrene block copolymer (KRATON® D 1107) elastomeric bonding agent, followed by drying. The elastic modulus of the bonding agent was 200 psi (1.38 MPa) as measured by ASTM D638-03. The coated felt sheet was placed between two 0.00035 in (0.0089 mm) thick linear low density polyethylene films. The ensemble of the coated felt sheet sandwiched between plastic films was placed in a press and compressed at 200 psi (1.38 MPa) at a temperature of 116° C. for one hour. At the end of this time, a laminate of the invention having plastic films on both surfaces and a bonding agent between the felt and the plastic films was removed from the press and cooled to room temperature.

### Example 10

Fifteen laminates were prepared as in Example 9 and stacked together face-to-face. The article of the invention consisting of the stack of unconnected laminates, having dimensions of 16 in×16 in×1.21 in (41 cm×41 cm×3.07 cm), was clamped around its edges in the edge portion and subjected to ballistic testing in a manner identical to that described in Comparative Example 1. Some properties of the article and results of the ballistic testing are shown in Table II below.

The assemblies of the invention had reduced back face deformation.

### Comparative Example 4

GOLD FLEX® material, commercially available from Honeywell International Inc., is a fibrous composite soft armor material consisting of four plies of uniaxially-aligned and cross-plied high strength aramid fibers in a matrix, consolidated with plastic films on both exterior surfaces. Seventeen sheets of GOLD FLEX® material were stacked together face-to-face to create an article having dimensions of 16 in×16 in×0.216 in (41 cm×41 cm×0.549 cm) and an areal density of 4.11 kg/m². The stack of GOLD FLEX® material was clamped around the edges in the edge portion and subjected to ballistic testing as described in Comparative Example 1. The results were as follows:

V50: 511 m/sec

SEA: 35 J-m²/Kg

### Example 11

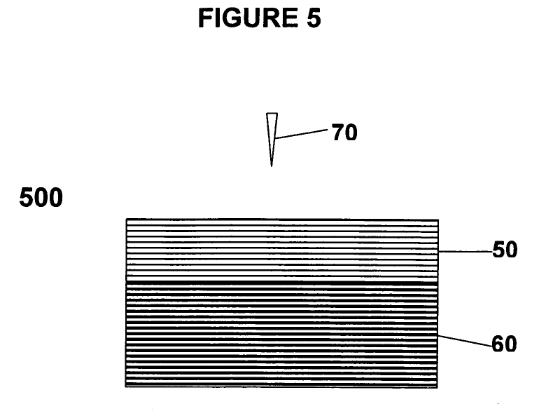

Six polyethylene fiber laminates of the invention were prepared as described in Example 3 and stacked together face-to-face. Eight sheets of GOLD FLEX® uniaxially aligned and cross-plied high strength aramid fibers in a matrix were stacked together face-to-face. The stack of laminates of the invention 50 and the stack of GOLD FLEX® fibrous composite sheets 60 were combined back-to-back as illustrated in FIG. 5 to form an article of the invention 500. The article had dimensions of 16 in×16 in×0.216 in (41 cm×41 cm×0.549 cm) and an areal density of 3.66 kg/m². This article was clamped around the edges in the edge portion and subjected to ballistic testing as described in Comparative Example 1. The projectile 70 entered the inventive laminate side of the article.

The results were as follows:

V50: 582 m/sec

SEA: 51 J-m²/Kg

TABLE II
Properties and Ballistic Performance of Inventive Articles

| | Percent by Wt. of | | | | | | | |
|---|---|---|---|---|---|---|---|---|
| | Article | | Article Properties | | | | | |
| | | Bonding | Thickness, | Areal Density, | Density, | V50 Velocity, | SEA, | Back Face |
| Ex. | Film | Agent | cm | Kg/m² | g/cm³ | m/sec | J − m²/Kg | Deformation, mm |
| Comp. 3 | — | — | 5.14 | 3.61 | 0.070 | 573 | 50 | 64 |
| 8 | 2 | — | 2.29 | 3.68 | 0.159 | 565 | 40 | 34 |
| 10 | 2 | 2 | 3.07 | 4.25 | 0.138 | 569 | 42 | 29 |

Fiber: 50 wt. % polyethylene (SPECTRA ® 1000 brand): 50 wt. % aramid (TWARON ® HT brand)
Fiber Strengths: 38 g/d: 25 g/d
Chopped Fiber Length: 3.0 in. (7.6 cm)
Areal Density of Single Felt Sheet: 0.0486 lb/ft² (0.24 Kg/m²)
No. of Laminates or Felt Sheets: 15
Film: LLDPE, 0.00035 in. (0.0089 mm)
Projectile: 17 gr. FSP

### Example 12

Seven polyethylene/aramid fiber laminates of the invention were prepared as described in Example 7 and stacked together face-to-face. Eight sheets of GOLD FLEX® uniaxially aligned and cross-plied high strength aramid fibers in a matrix were stacked together face-to-face. The stack of laminates of the invention and the stack of GOLD FLEX®® sheets were combined back-to-back as illustrated in FIG. 5 to form an article of the invention having dimensions of 16 in×16 in×0.391 in (41 cm×41 cm×0.993 cm) and an areal density of 4.10 kg/m². This article was clamped around the edges in the edge portion and subjected to ballistic testing as described in Comparative Example 1. The projectile 70 entered the inventive laminate side of the article.

The results were as follows:

V50: 520 m/sec

SEA: 36 J-m²/Kg

### Comparative Example 5

Twenty-six high strength polyethylene fiber felt sheets identical to that described in Comparative Example 1 were stacked together face-to-face, clamped around their edges in the edge portion and subjected to testing for stab resistance by NIJ Standard 01150.00, September 2000 with the P1 blade and with the “engineered spike”. The results are presented in Table III.

### Comparative Example 6

Thirty sheets of GOLD FLEX® uniaxially aligned and cross-plied high strength aramid fibers in a matrix were stacked together face-to-face, clamped together around their edges in the edge portion and subjected to testing for stab resistance by NIJ Standard 01150.00, September 2000, with the P1 blade and with the “engineered spike”. The results are presented in Table III.

### Example 13

A high strength polyethylene fiber felt sheet identical to that described in Comparative Example 1 was coated on both surfaces with a cyclohexane solution of a styrene-isoprene-styrene block copolymer (KRATON® D 1107) elastomeric bonding agent, followed by drying. The felt was placed between two 0.010 in (0.254 mm) thick polycarbonate plastic films. The ensemble of the felt sheet sandwiched between plastic films was placed in a press and compressed at 200 psi (1.38 MPa) at a temperature of 116° C. for one hour. At the end of this time, a laminate of the invention having plastic films on both surfaces was removed from the press and cooled to room temperature. The laminate was placed back-to-back with a stack of 30 sheets of GOLD FLEX® material as illustrated in FIG. 5 to form an article of the invention.

This article was subjected to testing for stab resistance by NIJ Standard 01150.00, September 2000, with the P1 blade. A second identical article was tested by NIJ Standard 01150.00, September 2000, with the “engineered spike”. The inventive laminate faced the threat. The results are presented in Table III.

### Example 14

Two laminates of the invention were prepared in an identical manner to that described in Example 13 and stacked together face-to-face. The stack of laminates was stacked together back-to-back with a stack of 30 sheets of GOLD FLEX® material as illustrated in FIG. 3 to form an article of the invention. This article was subjected to testing for stab resistance by NIJ Standard 01150.00, September 2000, with the P1 blade. A second identical article was tested by NIJ Standard 01150.00, September 2000, with the “engineered spike”. The inventive laminates faced the threat. The results are presented in Table III.

### Example 15

Four laminates of the invention were prepared in an identical manner to that described in Example 13 and stacked together face-to-face. The stack of laminates was stacked together back-to-back with a stack of 30 sheets of GOLD FLEX® material as illustrated in FIG. 3 to form an article of the invention. This article was subjected to testing for stab resistance by NIJ Standard 01150.00, September 2000, with the P1 blade.

A second identical article was tested by NIJ Standard 01150.00, September 2000, with the “engineered spike”. The inventive laminates faced the threat. The results are presented in Table III.

These articles of the invention met the requirements of NIJ Standard 01150.00, September 2000, for stab resistance at Protection Level I.

### Example 16

A high strength polyethylene fiber felt sheet identical to that described in Comparative Example 1 was coated on both surfaces with a cyclohexane solution of a styrene-isoprene-styrene block copolymer (KRATON® D1107) elastomeric bonding agent, followed by drying. The felt was placed between two 0.005 in (0.127 mm) thick polyester plastic films. The ensemble of the felt sheet sandwiched between plastic films was placed in a press and compressed at 200 psi (1.38 MPa) at a temperature of 116° C. for one hour. At the end of this time, a laminate of the invention having plastic films on both surfaces was removed from the press and cooled to room temperature. Two additional laminates of the invention were prepared in an identical manner and the three laminates were stacked together face-to-face.

The stack of laminates was stacked back-to-back with 30 sheets of GOLD FLEX® material as illustrated in FIG. 5 to form an article of the invention.

This article was subjected to testing for stab resistance by NIJ Standard 01150.00, September 2000, with the P1 blade. The inventive laminates faced the threat. The results with the P1 blade are presented in Table III.

### Example 17

Four laminates of the invention were prepared in an identical manner to that described in Example 16 and stacked together face-to-face. The stack of laminates was stacked together back-to-back with a stack of 30 sheets of GOLD FLEX® material as illustrated in FIG. 5 to form an article of the invention. This article was subjected to testing for stab resistance by NIJ Standard 01150.00, September 2000, with the “engineered spike”. The inventive laminates faced the threat. The results are shown in Table III.

It is seen that the articles of the invention are more resistant to penetration by stabbing implements than a felt material. The penetration depth against the “engineered spike” satisfies the following inequality:

Penetration Depth, mm<220/Article Areal Density, Kg/m²

### Example 18

Thirteen laminates of the invention are prepared as described in Example 5. The laminates are stacked together face-to-face. The stack is placed in a press and a pressure of 2000 psi (13.8 MPa) is applied for one hour at a temperature of 116° C. to bond the laminates together. The article of the invention is removed from the press and cooled to room temperature.

It is believed that the ballistic resistance and/or stab resistance of the article is similar to that seen in Example 6.

### Example 19

A rigid plate is formed by stacking eight sheets of GOLD FLEX® material together and bonding them together in a press at a pressure of 1000 psi (6.9 MPa) for one hour at 120° C. Six laminates of the invention are prepared as described in Example 3 and stacked together with the rigid plate to create an article of the invention. It is believed that the ballistic resistance of this article, with the laminates of the invention facing the threat, will be similar to that of Example 11.

### Example 20

A rigid plate is formed by stacking eight sheets of GOLD FLEX® material together and bonding them together in a press at a pressure of 1000 psi (6.9 MPa) for one hour at 120° C. Six laminates of the invention are prepared as described in Example 5, and then are bonded together and with the rigid plate at a pressure of 1000 psi (6.9 MPa) for one hour at 120° C. to create an article of the invention. It is believed that the ballistic resistance of this article, with the laminates of the invention facing the threat, will be similar to that of Example 11.

TABLE III
Stab Resistance by NIJ-STD-0115.00

| | No. of Layers | | | | | | |
|---|---|---|---|---|---|---|---|
| | | SPECTRA | | Target | | Target | |
| | GOLDFLEX ® | Fiber-Based | Inventive | Thickness, | Target Areal | Density | Penetration, |
| Example | Material | Felt | Laminates | cm | Density, Kg/m² | g/cm 3 | mm |
| P1 Blade | | | | | | | |
| Comp. 5 | — | 26 | — | 9.30 | 6.94 | 0.075 | >70 |
| Comp. 6 | 30 | — | — | 0.67 | 6.99 | 1.038 | 40 |
| 13 | 30 | — | 1 (PC) | 0.76 | 7.97 | 1.045 | 34 |
| 14 | 30 | — | 2 (PC) | 0.86 | 8.99 | 1.041 | 30 |
| 15 | 30 | — | 4 (PC) | 0.97 | 11.04 | 1.021 | 15 |
| 16 | 30 | — | 3 (PET) | 0.72 | 9.04 | 1.249 | 27 |
| Spike | | | | | | | |
| Comp. 5 | | 26 | — | 9.30 | 6.94 | 0.075 | >70 |
| Comp. 6 | 30 | — | — | 0.67 | 6.99 | 1.038 | 43 |
| 14 | 30 | 2 | 2 (PC) | 0.86 | 8.99 | 1.041 | 32 |
| 15 | 30 | 4 | 4 (PC) | 1.08 | 11.04 | 1.021 | 19 |
| 17 | 30 | 4 | 4 (PET) | 0.97 | 10.36 | 1.068 | 23 |

Penetrator Energy: 36 ± 0.5 Joules
(PC): polycarbonate plastic films on inventive laminates
(PET): polyester plastic films on inventive laminates

### Example 21

Thirteen laminates of the invention are prepared as in Example 3 and stacked together face-to-face. A 0.25 inch (0.635 cm) thick aluminum oxide ceramic plate is stacked together with the laminates to create an article of the invention. It is believed that the ballistic resistance of this article, with the ceramic plate facing the threat, will be superior to that of Example 4.

### Example 22

Thirteen laminates of the invention are prepared as in Example 3 and stacked together face-to-face. A cyclohexane solution of a styrene-isoprene-styrene block copolymer (KRATONO D 1107) elastomeric bonding agent is applied to a 0.25 inch (0.635 cm) thick aluminum oxide ceramic plate and dried, The ceramic plate is applied to the stack of laminates, bonding agent side down, and the laminates and the ceramic plate are bonded together in a press at 1000 psi (6.89 MPa) for one hour at 120° C. to create an article of the invention.

It is believed that the ballistic resistance of this article, with the ceramic plate facing the threat, will be superior to that of Example 4.

Having thus described the invention in rather full detail, it will be understood that such detail need not be strictly adhered to but that further changes and modifications may suggest themselves to one skilled in the alt, all falling within the scope of the invention as defined by the subjoined claims.

1. A free-standing laminate of comprising:
(a) a needle-punched and additionally compressed felt sheet having a needle punch density of from about 15.5 to about 310 punches/cm², said felt sheet having two lateral surfaces, and consisting essentially of one or more high strength fibers having a tenacity equal to or greater than about 17 grams per denier as measured by ASTM D2256-02;
(b) a plastic film bonded to at least one of the lateral surfaces of said felt sheet at a temperature that is either below the melting point of the high strength fibers or below the softening point of the plastic film; and
(c) optionally, a bonding agent between said felt sheet surface and said plastic film.

2. The laminate of claim 1, having an areal density of from about 0.1 Kg/m² to about 2 Kg/m².

3. The laminate of claim 1, having a density from about 0.05 g/cm³ to about 1.5 g/cm³.

4. The laminate of claim 1, wherein said high strength fibers are selected from the group consisting of polyolefin, polyaramid, polybenzazole, polyvinyl alcohol, and poly{2,6-diimidazo[4,5-b4′,5′-e]pyridinylene-1,4(2,5-dihydroxy)phenylene} (PIPD) fibers.

5. The laminate of claim 4, wherein said high strength fibers are selected from the group consisting of polyethylene, poly(p-phenylene terephthalamide), polybenzoxazole (PBO), and poly{2,6-diimidazo[4,5-b4′,5′-e]pyridinylene-1,4(2,5-dihydroxy)phenylene} (PIPD) fibers.

6. The laminate of claim 1, wherein at least one said high strength fiber consists of discontinuous filaments of lengths of from about 1 inch to about 10 inches (2.5 to 25 cm).

7. The laminate of claim 1, wherein said plastic film is selected from the group consisting of polyolefin, polyamide, polycarbonate, ionomer, polyimide, polyvinyl chloride, polyester and polyurethane films.

8. The laminate of claim 1, wherein said plastic film has a thickness from about 0.008 millimeters to about 1 millimeter.

9. The laminate of claim 1 having an apparent bending modulus less than about 10 psi (69 KPa) as measured by ASTM 747-93.

10. The laminate of claim 1 having an apparent bending modulus less than about 5 psi (34.5 KPa) as measured by ASTM 747-93.

11. The laminate of claim 1 having an apparent bending modulus less than about 2 psi (13.8 KPa) as measured by ASTM 747-93.

12. The laminate of claim 1, wherein said bonding agent is an elastomeric material having an elastic modulus less than about 41.3 MPa as measured by ASTM D638-03.

13. The laminate of claim 1, wherein said bonding agent comprises from about 1 to about 10 percent by weight of the laminate.

14. An article comprising two or more laminates as described in claim 1 stacked together in face-to-face relationship, wherein said laminates are connected only in an edge portion.

15. An article comprising two or more laminates as described in claim 1 in face-to-face relationship, wherein said laminates are not connected.

16. An article comprising two or more laminates as described in claim 1 bonded together in face-to-face relationship.

17. An article as described in claim 15 having against the 17 grain (1.1 gram) fragment simulating projectiles described by MIL-P-46593A, a V50 velocity of at least about 1800 ft/sec (549 m/sec), a specific energy absorption (SEA) at least about 50 J-m2/Kg and a back face deformation at the V50 velocity less than about 55 mm as measured by MIL-STD-662E.

18. An article as described in claim 15 meeting the requirements of NIJ Standard 01150.00 for stab resistance at Protection Level 1.

19. An article as described in claim 15, wherein against the “engineered spike” threat at a strike energy of 36 Joules, the penetration depth in millimeters, as measured by NIJ Standard 01150.00, September 2000, satisfies the following inequality:
Penetration Depth, mm<200/Article Areal Density, Kg/m².

20. An article comprising:
(a) one or more laminates as described in claim 1;
(b) one or more fibrous layers selected from the group consisting of woven sheets of high strength fibers, sheets of uniaxially-aligned and cross-plied high strength fibers in a matrix, sheets of uniaxially-aligned and cross-plied high strength fibers laminated in a plastic film, said high strength fibers having a tenacity at least about 17 g/d;
wherein said fibrous layers and said laminates as described in claim 1 are stacked together in face-to-face relationship.

21. An article comprising:
(a) one or more laminates as described in claim 1;
(b) a rigid plate selected from the group consisting of:
(i) sheets of woven high strength fibers in a matrix bonded together,
(ii) sheets of uniaxially-aligned and cross-plied high strength fibers in a matrix bonded together,
(iii) sheets of uniaxially-aligned and cross-plied high strength fibers laminated in a plastic film bonded together, and
wherein said rigid plate and said laminates as described in claim 1 are stacked together in face-to-face relationship.

22. The article of claim 21, wherein said laminates are bonded together and to said rigid plate.

23. An article comprising:
(a) one or more laminates as described in claim 1;
(b) a rigid plate selected from the group consisting of a ceramic, a glass, a metal-filled composite, a ceramic-filled composite, a glass-filled composite and a cermet:
wherein said rigid plate and said laminates as described in claim 1 are stacked together in face-to-face relationship.

24. The article of claim 23, wherein said laminates as described in claim 1 are bonded together and to said rigid plate.

25. A free-standing laminate comprising:
(a) a needle-punched felt and additionally compressed felt sheet having a needle punch density of from about 15.5 to about 310 punches/cm², said felt sheet having two lateral surfaces and consisting essentially of one or more high strength fibers having a tenacity equal to or greater than about 17 grams per denier as measured by ASTM D2256-02;
(b) a plastic film bonded to both lateral surfaces of said felt sheet at a temperature that is either below the melting point of the high strength fibers or below the softening point of the plastic film, and
(c) optionally, a bonding agent between said felt sheet surfaces and said plastic films.

26. An article comprising two or more laminates as described in claim 25 in face-to-face relationship, wherein said laminates are not connected.

27. An article comprising two or more laminates as described in claim 25 stacked together in face-to-face relationship, wherein said laminates are connected only in an edge portion.

28. An article comprising two or more laminates as described in claim 25 bonded together in face-to-face relationship.

29. An article as described in claim 26 having against the 17 grain (1.1 gram) fragment simulating projectiles described by MIL-P-46593A. a V50 velocity of at least about 1800 ft/sec (549 m/sec), a specific energy absorption (SEA) at least about 50 J-m2/Kg and a back face deformation at the V50 velocity less than about 55 mm as measured by MIL-STD-662E.

30. An article as described in claim 26, meeting the requirements of NIJ Standard 01150.00 for stab resistance at Protection Level 1.

31. An article as described in claim 26, wherein against the “engineered spike” threat at a strike energy of 36 Joules, the penetration depth in millimeters, as measured by NIJ Standard 01150.00, September 2000, satisfies the following inequality:
Penetration Depth, mm<220/Article Areal Density, Kg/m².
